(19) United States
(12) Patent Application Publication
(10) Pub. No.: US 2026/0266422 A1
(43) Pub. Date: Sep. 10, 2026

(54) MOUNTING MECHANISM

(71) Applicant: MORPH DESIGN LTD, Ottawa (CA)

(72) Inventors: Robert GALLOWAY-BLACKBURN, Ottawa (CA); Andrew KENT, Ottawa (CA); Julia DICKSON, Kanata (CA)

(21) Appl. No.: 19/165,295

(22) PCT Filed: Mar. 18, 2024
(86) PCT No.: PCT/CA2024/050322

§ 371 Date: Sep. 15, 2025

Related U.S. Application Data
(60) Provisional application No. 63/452,829, filed on Mar. 17, 2023.

(51) Int. Cl. F16M 13/02; A47B 95/00; A47B 96/02; A47G 1/16; A47G 1/22; F16B 12/24

(52) U.S. Cl. CPC F16M 13/02; A47B 95/008; A47B 96/02; A47G 1/1606; A47G 1/22; F16B 12/24; A47B 2230/0085; A47B 2230/0092; F16B 2200/83

(57) ABSTRACT

The present disclosure provides a mounting mechanism. The mounting mechanism is further comprised of a magnet magnetically engaged with a pin, the pin configured to penetrate into a wall or other structure. The pin is surrounded by a spring that retains the magnet, the spring positioning and stabilizing the pin within the cavity. In a preferred embodiment, the mounting mechanism is substantially positioned within a cavity of an object such as a shelving unit. In another embodiment a spear pin is provided, the spear pin comprised of threaded end and a winged end terminating in a tip at an opposed end of the threaded end.

### FIELD

The invention relates to the field of fasteners, and more specifically to a mounting mechanism that may be used with surface-mounted objects.

### BACKGROUND

Various mounting mechanisms to secure an object such as a frame or a shelf have been devised to facilitate their installation, cleaning and removal to and from a surface such as a wall. It is desirous for these mechanisms to be cost-effective, easy to install, easy to ship and appeal to the eye.

More specifically, inventions such as U.S. Pat. No. 2,729,815 (Browning), U.S. Pat. No. 4,618,430 (Hogg), U.S. Pat. No. 5,267,718 (Sheehan), U.S. Pat. No. 8,572,873 (Bortel) and U.S. Pat. No. 8,974,166 (McDuff) have been devised to position an object such as a frame, shelf, anchor or hook structure to a wall.

Bortel in particular teaches a frame with an integrated attachment to secure a frame to a wall. Unfortunately, Bortel requires a number of tools to attach the frame, and the integrated attachment is secured straight into the wall. Being secured straight into the wall does not set the integrated attachment at the ideal angle, compromising the structural integrity of the attachment.

Other inventions teach captive pins that protrude from the frame itself. Unfortunately, these types of products create shipping and packaging issues due to their irregular shape. Additionally, when frames are mounted, an operator must remove the entire frame including the mounting system (e.g. captive pins) during cleaning, painting or when changing the frame. This may result in damage to the wall upon removal or insertion of the frame. Additionally, the mounting system can be weakened or destroyed when reinstalling the frame.

Other inventions teach removable pins; however, these are typically small nails whose tips are not conically shaped. Further, often removeable pins are not securely fastened and do not provide any haptic or audible feedback when properly assembled. This makes penetration into the wall more difficult, reduces the potential load of the frame or shelf and can lead to consumer confusion not knowing if the object is properly installed.

As such, there is a need for an improved mounting mechanism to overcome these deficiencies. More specifically, there is a need for an improved mounting mechanism that can be secured to a wall without any tools or other assistance objects, that can be packaged as small as possible and shipped flat without protruding pins, allow mounted objects to be removed and replaced safely from the wall without damaging the wall or the item, and allow mounted objects to be hung flush with the wall. An improved mounting mechanism would also provide haptic and auditory feedback to indicate that the object has been properly secured. Finally, an improved mounting mechanism would be very small and partially hidden within a cavity of the object to allow very thin objects to be flushly mounted to a surface without showing the mechanism.

### SUMMARY

In an aspect, the present disclosure provides a wall-mounted structure, the structure comprising: a first frame having at least one cavity; and, a mounting mechanism positioned within the at least one cavity of the first frame, the mounting mechanism to secure the frame to the wall.

In another aspect, the present disclosure provides a spear pin to secure an object to a wall, the spear pin further comprising: a connecting end; a winged end terminating in a tip, the winged end opposite the connecting end, the winged end comprised of two opposed wings.

In yet another aspect, the present disclosure provides a mounting mechanism comprising: a magnet; and, a pin in magnetic engagement with the magnet, the mounting mechanism configured to be partially positioned within a cavity of an object for securing the object to a surface.

### BRIEF DESCRIPTION OF THE DRAWINGS

The following figures serve to illustrate various embodiments of features of the disclosure. These figures are illustrative and are not intended to be limiting.

FIG. 1 is a perspective view of a shelving unit having three mounting mechanisms, according to an embodiment of the present disclosure;

FIG. 2 is a perspective view of the shelving unit of FIG. 1 without two of the mounting mechanisms, according to an embodiment of the present disclosure;

FIG. 3 is a perspective view of the shelving unit of FIG. 2 with a first frame rotated with respect to a second frame, according to an embodiment of the present disclosure;

FIG. 4 is an enlarged, perspective cross-sectional view of the shelving unit of FIG. 1 showing the interconnection between the first and second frames, according to an embodiment of the present disclosure;

FIG. 5 is an enlarged, perspective cross-sectional view of the mounting mechanism secured within a cavity of the first frame of FIG. 1, according to an embodiment of the present disclosure;

FIG. 6A is an enlarged perspective view of the mounting mechanism of FIG. 1, according to an embodiment of the present disclosure;

FIG. 6B is an enlarged perspective view of the pin of FIG. 1, according to an embodiment of the present disclosure;

FIG. 7 is an enlarged perspective view of a mounting mechanism, according to another embodiment of the present disclosure;

FIG. 8 is an enlarged cross-sectional perspective view of the mounting mechanism of FIG. 7, according to another embodiment of the present disclosure;

FIG. 9 is a perspective view of the mounting mechanism of FIG. 7 secured to an object, according to another embodiment of the present disclosure;

FIG. 10 is a perspective view of a spear pin, according to another embodiment of the present disclosure; and,

FIG. 11 is a cross-sectional front view of the spear pin of FIG. 10 inserted within a wall, according to another embodiment of the present disclosure.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

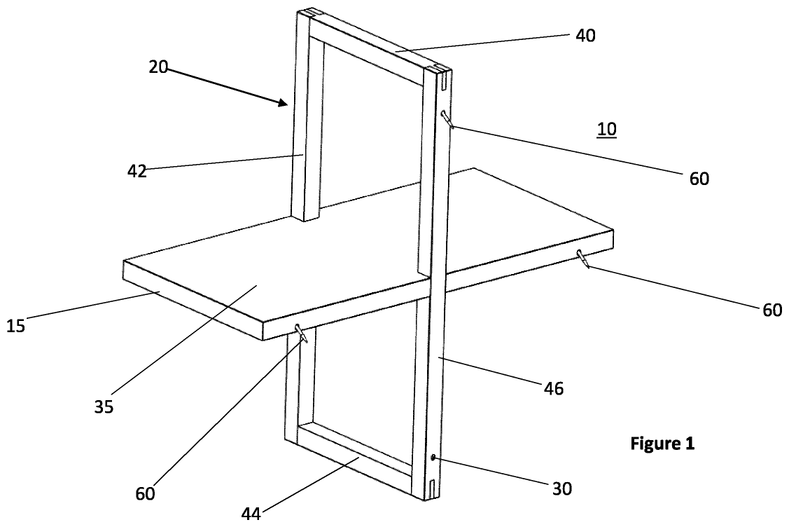

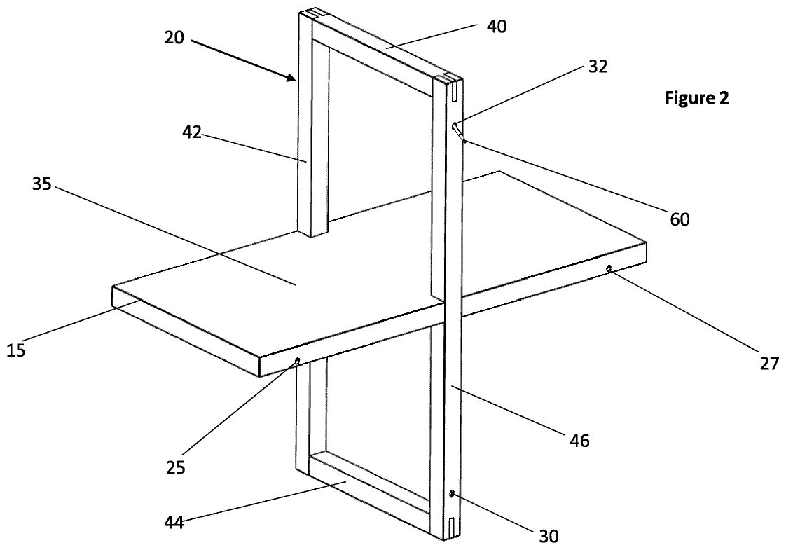

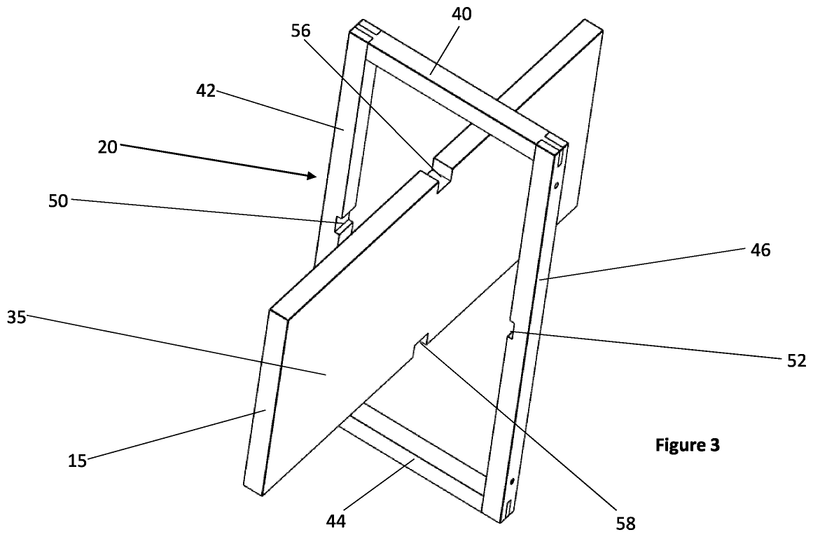

With reference to FIGS. 1, 2 and 3 and according to an embodiment of the present disclosure, a shelving unit 10 is shown, the shelving unit 10 preferably comprised of first and second frames 15, 20 interconnected to one another. The first frame 15 is further comprised of first and second cavities 25, 27 and the second frame 20 is further comprised of third and fourth cavities 30, 32. Although two cavities are shown for each frame 15, 20, a worker skilled in the art would appreciate that only a single cavity or more than two cavities are possible, depending on the shape and size of the frame. Each one of the first and second frames 15, 20 are comprised of at least one mounting mechanism 60 to attach the first and second frames 15, 20, to a surface such as a wall. The mounting mechanism 60 is partially positioned within the cavities 25, 27, 30, 32 of the first and second frames 15, 20. In this preferred embodiment, the first frame 15 is a substantially rectangular shaped piece having a planar surface 35. Meanwhile, the second frame 20 is further comprised of four segments 40, 42, 44, 46 interconnected one into another by tongues (not shown) and grooves (not shown) to form a substantially rectangular border. As best shown in FIG. 3, inner walls of segments 42 and 46 of the second frame 20 are further comprised of indentations 50, 52, respectively. The first frame 15 is further comprised of notches 56, 58 positioned on each side of the frame 15. In an exemplary embodiment, the indentations 50, 52 are configured to receive corresponding notches 56, 58 to interconnect and lock the first frame 15 into the second frame 20. In this locked configuration as specifically shown in FIGS. 1 and 2, the first frame 15 can receive an object on the surface 35, such as a picture cadre, decorations, a decorative figure, small potted plants, etc.

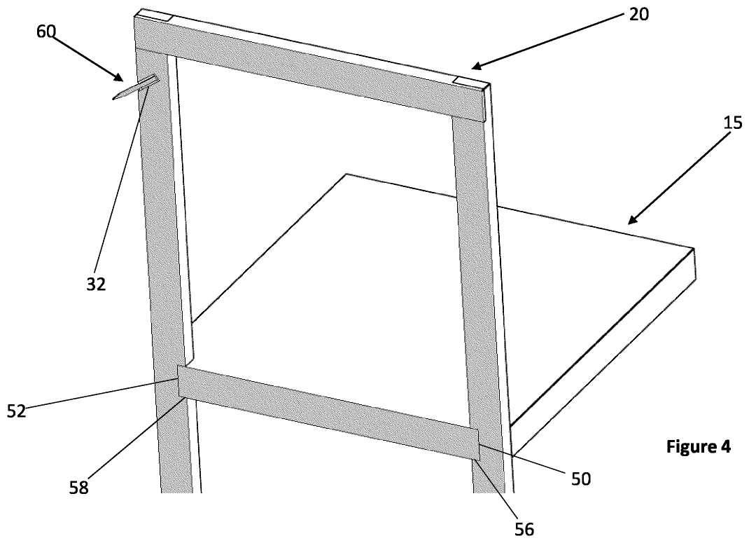

With reference to FIG. 4 and according to an embodiment of the present disclosure, the second frame 20 is shown interconnected and secured to the first frame 15. The notches 56, 58 of the first frame 15 are shown locked into and resting on corresponding indentations 50, 52 of the second frame 20. A mounting mechanism 60 is also shown partially positioned within a cavity 32 of the second frame 20. The cavity 32 has a downward slope to provide a similar downward slope of the mounting mechanism 60, which helps facilitate the retention of the frame 20 onto a surface.

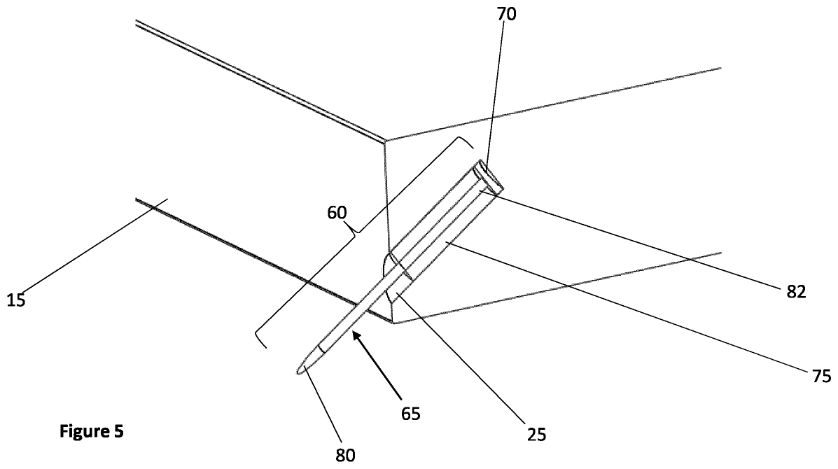

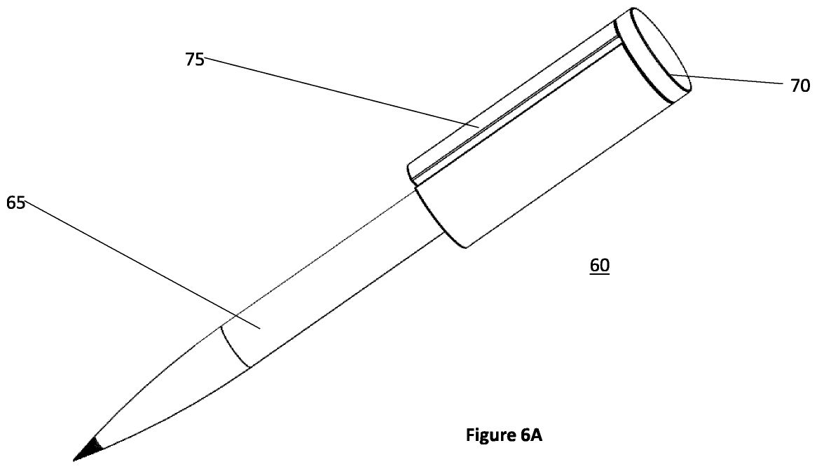

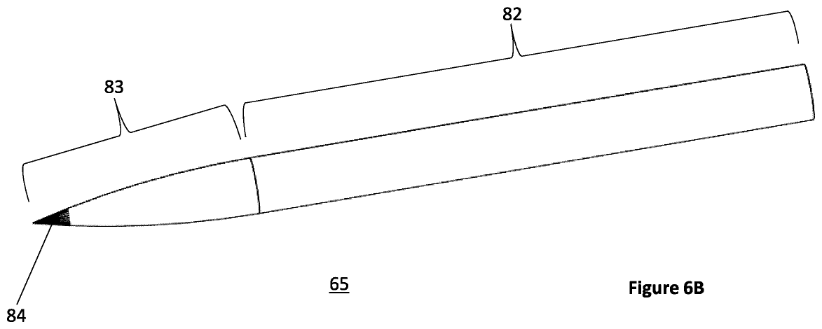

With reference to FIGS. 5 and 6A and according to an embodiment of the present disclosure, the mounting mechanism 60 is further comprised of a pin 65 magnetically engaged with a magnet 70. The mounting mechanism 60 is also comprised of a spring 75 engaged with the magnet 70, the spring 75 wrapped around a lower half of the pin 65. In this embodiment, the mounting mechanism 60 is partially positioned within the cavity 25 of the first frame 15. As shown, an upper half of the pin 65 protrudes from the cavity 25. As the cavity 25 is angled downwardly, the mounting mechanism 60 is similarly at a downward angle with respect to the ground. This downward angle is advantageous as it facilitates retention of the shelving unit (not shown) onto a surface such as a wall. The downward angle also reduces the moment (i.e. torque) in comparison to a similar pin set perpendicular to the surface. In a preferred embodiment, the spring 75 is positioned in place and secured within the cavity 25 by friction fit. A purpose of the spring 75 is to engage with the magnet 70 to retain the magnet 70 within the lower end of the cavity 25. In another embodiment, a worker skilled in the art would appreciate that the magnet could be injection molded within the cavity 25, or otherwise secured within the cavity 25 by friction fit, glue, etc. In such an embodiment, the spring 75 may be absent from the mounting mechanism 60 completely, such that the mounting mechanism 60 is comprised of the pin 65 and magnet 70. In this exemplary embodiment, the pin 65 could have a larger diameter to fit snugly and flushly within the cavity 25; or alternatively, the cavity 25 could be smaller to fit snugly and flushly around a smaller pin 65. In the present embodiment, the magnet 70 and spring 75 hold the pin 65 in place within the cavity 25 so that the pin 65 does not fall out. Before the installation of the first frame 15 onto the surface, the pin 65 is inserted into the cavity 25 and within the spring 75. The pin 65 is inserted towards the magnet 70 positioned at the lowermost end of the cavity 25. Once the pin 65 has been sufficiently inserted, the magnet 70 will magnetically engage the pin 65 such that the pin 65 abuts against the magnet 70, and an operator will receive both haptic and auditory feedback to know that the mounting mechanism 60 is set. During installation of the first frame 15, the first frame 15 is pushed against the wall, which forces a tip 80 of the pin 65 into the wall. A lower end 82 of the pin 65 remains biased against the magnet 70. The magnet 70 has a wide surface area to accommodate the lower end 82 of the pin 65 and facilitate the driving down of the pin 65 into the wall. The spring 75 has an elongated, cylindrical shape adapted to distribute movement of the pin 65 when the shelving unit (not shown) is being secured to a wall. In other words, during installation when the pin 65 is being driven into the wall, radial forces may be exerted on the pin 65, forcing it side to side within the cavity 25. A purpose of the spring 75 is to reduce or eliminate this sideways, radial movement and better drive the pin 65 into the wall. In the alternate embodiment described above without the spring 75, the pin 65 would have a larger diameter such that the inner walls of the cavity 25 would reduce or eliminate the sideways movement of the pin 65 during installation on the surface. In the present embodiment, the spring 75 is also comprised of a bevel or a chamfer (not shown) at each end thereof. A purpose of the bevel (or chamfer) is to help insertion of the spring 75 into the cavity 25. A worker skilled in the art would appreciate that the pin 65 is not permanently secured within the mounting mechanism 60. The pin 65 is temporarily held in place in the mounting mechanism 60 by means of magnetic attraction to the magnet 70 and friction fit from the spring 75. As such, once the shelving unit (not shown) is installed and secured to the wall, the force of the pin 65 secured into the wall is stronger than the magnetic and friction force that was holding the pin 65 to the spring 75 and magnet 70 such that the pin 65 becomes secured within the wall. If the shelving unit (not shown) needs to be removed, the pin 65 will remain in the wall.

With reference to FIG. 6b and according to a preferred embodiment of the present disclosure, the pin 65 is shown. A worker skilled in the art would appreciate that in this preferred embodiment, the pin 65 is comprised of a first cylindrical portion 82 and a second tapering portion 83 terminating in a tip 84. It is the first cylindrical portion 82 that allows the pin 65 to be properly positioned within a cavity (not shown) of an object.

With further reference to FIGS. 1 and 4 and according to an embodiment of the present disclosure, the shelving unit 10 can be secured to a wall with the mounting mechanism 60. In a first step, the shelving unit 10 and mounting mechanism 60 are aligned in the proper orientation against the wall. Once the pin 65 touches the wall, the shelving unit 10 and thus the mounting mechanism 60 are pushed against the wall, until the pin 65 of the mounting mechanism 60 has penetrated the wall and the shelving unit 10 is flush against the wall. As the mounting mechanism 60 is positioned within the cavity 32 at a downward angle relative to the ground, the mounting mechanism 60 is self-guided downwardly and properly into the wall. When the shelving unit 10 is flush against the wall and therefore fully secured thereto, the mounting mechanism 60 is completely hidden from view, which is an advantage of the present disclosure.

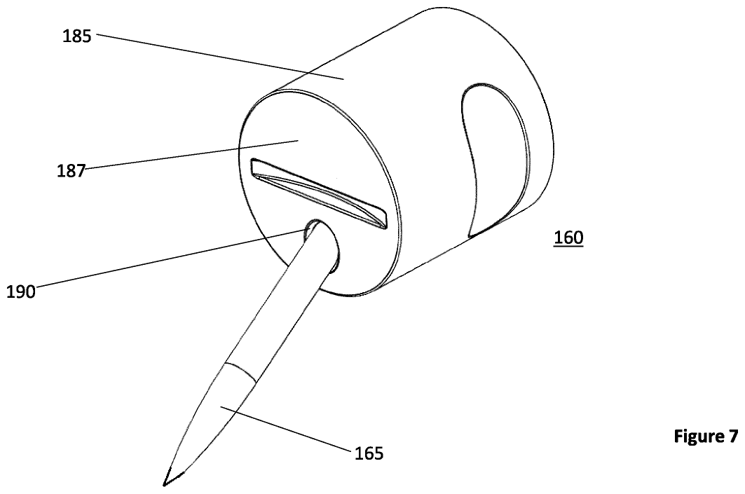

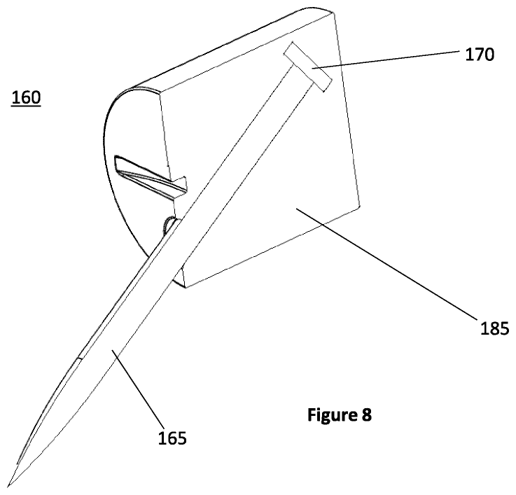

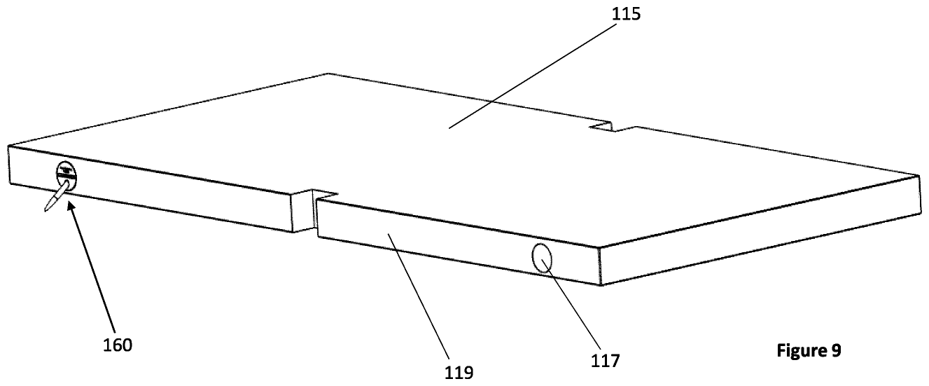

With reference to FIGS. 7, 8 and 9 and according to an embodiment of the present disclosure, a mounting mechanism 160 is shown, the mounting mechanism 160 to secure an object 115 to a wall. In this particular embodiment, the mounting mechanism 160 is further comprised of a plug 185, the plug 185 configured to be moulded around a magnet 170. During installation of the object 115 onto the wall, the plug 185 is positioned and secured within a cavity 117 of the object 115. Preferably, the front face 187 of the plug 185 is flush with a corresponding surface 119 of the object 115 to be positioned against the wall. As shown, the magnet 170 is moulded directly into or otherwise secured within the plug 185. The pin 165 is then inserted into an opening 190 of the plug 185, until the pin 165 engages with the magnet 170. Once the pin 165 is engaged with the magnet 170, the pin 165 partially protrudes from the plug 185. The opening 190 is configured to receive the pin 165 snugly and flushly, so as to prevent unwanted sideways movement of the pin 165. When the object 115 is pushed toward the wall, the pin 165 penetrates the wall and serves to secure the surface 119 of the object 115 flushly against the wall.

A worker skilled in the art would appreciate that although reference is made to shelving units comprising first and second frames, the mounting mechanism can be applied to any number of objects to be secured to any number of surfaces, although drywall would be the preferred surface. Preferably, the object would simply be comprised of an angled cavity to receive the mounting mechanism and be secured to a surface. In another embodiment, the mounting mechanism is suited for objects that are taller and wider with respect to their depth, to minimize cantilever and torque forces on the location 1 of the mounting mechanism.

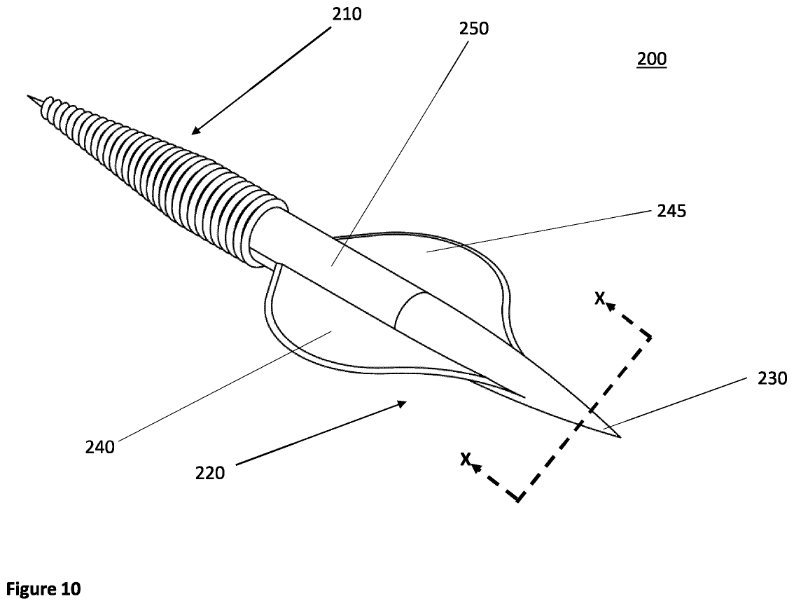

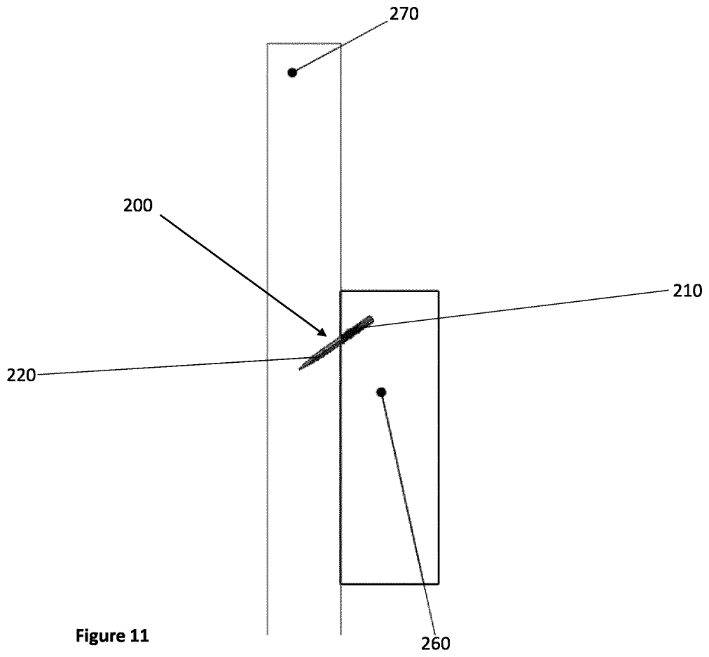

With reference to FIGS. 10 and 11 and according to another embodiment of the present disclosure, a spear pin 200 is shown. Spear pin 200 has a connecting end 210 that is threaded with an opposing spear end 220 terminating in a spear point 230. Spear end 220 is comprised of two opposed wings 240, 245 separated by ridges 250 on each side of the wings 240, 245. The ridges 250 add stiffness to prevent the spear end 220 from bending. In an embodiment, the wings 240, 245 have a tapering thickness, such that the wings 240, 245 are slightly thicker near the ridges 250, and thinner near the lateral tips of the wings 240, 245. The tapering thickness also adds stiffness to the spear point 220 and prevents the wings 245, 245 from folding or breaking when the spear pin 200 is screwed in by hand. In an embodiment, the wings 240, 245 may be curved, such that when the spear pin 200 is viewed along the cross-section X-X, the wings 240, 245 form a generally S-shaped curve, the spear point 230 being at the center of the “S”. This optional curvature adds stiffness and may also add comfort when screwing the spear pin 200 in by hand. In another embodiment, other curves along the cross-section X-X are possible, including but not limited to: each wing 240, 245 having a general S-curve, a rounded shape (e.g. sinusoidal) and angular (e.g. zigzag or trapezoid). Ultimately, the purpose of the curve or shape is to stiffen the spear pin 200. In an embodiment, the trailing edges of the spear point 230 are angled away from the threaded end 210 to prevent the wings 240, 245 from contacting the object 260 when the spear pin 200 is screwed into the object 260 at an angle. The lateral outlines of the wings 240, 245 are rounded for added comfort when screwing the pin in by hand. Threaded end 210 allows for the pin 200 to be threaded into an object 260. Once pin 200 is threaded into an object 260, spear point 230 allows for pin 200 to penetrate a wall 270 and securing pin 200 to a wall 270. The presence of spear end 220 on pin 200 also allows to distribute the load of the object 260 secured to threaded end 210.

A worker skilled in the art would appreciate that in an embodiment, a method to secure an object to a structure is disclosed the steps comprising: aligning the mounting mechanism against the structure; and, pushing the object against the structure until the mounting mechanism has penetrated the wall and the object is flush against the structure, wherein the mounting mechanism is positioned at a downward angle with respect to the ground.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure which is not to be limited to the specific embodiment disclosed.

1. A wall-mounted structure, the structure comprising:
a first frame having at least one cavity; and,
a mounting mechanism positioned within the at least one cavity of the first frame, the mounting mechanism to secure the frame to the wall.

2. The wall-mounted structure of claim 1 wherein the mounting mechanism is further comprised of a pin and a magnet to hold the pin in place.

3. The wall-mounted structure of claim 2 wherein the mounting mechanism is further comprised of a spring having at least one bevel, the spring surrounding the pin.

4. The wall-mounted structure of claim 2 wherein the mounting mechanism is further comprised of a plug.

5. The wall-mounted structure of claim 2 wherein the pin is further comprised of a tapered lower end terminating in a tip.

6. The wall-mounted structure of claim 1 wherein the at least one cavity has a downward slope.

7. A spear pin to secure an object to a wall, the spear pin further comprising:
a connecting end;
a winged end terminating in a tip, the winged end opposite the connecting end, the winged end comprised of two opposed wings.

8. The spear pin of claim 7, wherein the two opposed wings are separated by a ridge.

9. The spear pin of claim 7 wherein the two opposed wings have a width that tapers from a thicker width in a center of the spear pin to a thinner width in an outer edge of the two opposed wings.

10. The spear pin of claim 7 wherein the two opposed wings are curved such that the spear pin has a cross-section that is one of:
S-shaped, rounded and angular, to add stiffness to the spear pin.

11. The spear pin of claim 7 wherein the connecting end is threaded.

12. A mounting mechanism comprising:
a magnet ; and,
a pin in magnetic engagement with the magnet,
the mounting mechanism configured to be partially positioned within a cavity of an object for securing the object to a surface.

13. The mounting mechanism of claim 12 further comprised of a spring to retain the magnet and surround the pin.

14. The mounting mechanism of claim 13 wherein the spring is further comprised of one of a bevel and a chamfer.

15. The mounting mechanism of claim 12 wherein the mounting mechanism is further comprised of a plug.
